(19) United States
(12) Patent Application Publication
(10) Pub. No.: US 2022/0385784 A1
(43) Pub. Date: Dec. 1, 2022

(54) IMAGE PROCESSING APPARATUS AND METHOD FOR CONTROLLING IMAGE PROCESSING APPARATUS

(71) Applicant: SHARP KABUSHIKI KAISHA, Sakai City (JP)

(72) Inventor: KUNIHISA CHIBA, Sakai City (JP)

(21) Appl. No.: 17/746,638

(22) Filed: May 17, 2022

(30) Foreign Application Priority Data
May 26, 2021 (JP) 2021-088505

(51) Int. Cl. H04N 1/32; H04N 1/00; H04N 1/44

(52) U.S. Cl. CPC H04N 1/32101; H04N 1/00933; H04N 1/00896; H04N 1/00413; H04N 1/32037; H04N 1/44; H04N 2201/3204; H04N 2201/3295; H04N 2201/3202

(57) ABSTRACT

According to an embodiment, an image processing apparatus includes a communicator, a storage, and a controller, in which the controller stores destination information received from a terminal device, via the communicator, in the storage, and erases the destination information from the storage in response to a trigger. In the image processing apparatus, the destination information is retained at least until a trigger input is made.

### BACKGROUND OF THE INVENTION

### Field of the Invention

The present disclosure relates to, for example, an image processing apparatus.

### Description of the Background Art

Image processing apparatuses, such as multifunction peripherals, include ones provided with the function of acquiring destination information such as e-mail addresses and fax numbers that are managed by a terminal device, which is, for example, a smartphone, a tablet, a cellular phone, or a personal computer. Some of the above-mentioned image processing apparatuses are known to be able to set the destination information, which has been acquired from the terminal device, to a transmission destination related to a job of a fax transmission function, an image transmission function, and the like, thereby transmitting image data to a destination not being managed by the apparatus itself.

Generally, from the standpoint of security, the destination information acquired from the terminal device is erased after execution of a job. For example, such an image processing apparatus is known, which erases, when a contact is not selected within a predetermined time after display of contact information acquired from a mobile terminal, the display and data of the contact information.

In a conventional technology, after executing a job by using destination information acquired from a terminal device, when reuse of the acquired destination information is desired, it is necessary to cooperate with the terminal device once again and reacquire the destination information. In addition, since the destination information used to execute the job is stored in history information as a setting value, the conventional technology has a problem of occurrence of leakage of the destination information from the history information.

An object of the present disclosure is to provide an image processing apparatus and the like capable of handling destination information with consideration to security, while ensuring convenience pertaining to the use of destination information acquired from a terminal device.

### SUMMARY OF THE INVENTION

In order to solve the above problem, an image processing apparatus according to the present disclosure is provided with a communicator, a storage, and a controller, and is characterized in that the controller stores destination information received from a terminal device, via the communicator, in the storage, and erases the destination information from the storage in response to a trigger, in which the destination information is retained at least until a trigger input is made.

Also, a method for controlling an image processing apparatus according to the present disclosure includes: the step of storing destination information received from a terminal device in a storage; and the step of erasing the destination information from the storage in response to a trigger, and is characterized in that the destination information is retained at least until a trigger input is made.

According to the present disclosure, it is possible to provide an image processing apparatus and the like capable of handling destination information with consideration to security, while ensuring convenience pertaining to the use of destination information acquired from a terminal device.

### BRIEF DESCRIPTION OF THE DRAWINGS

FIG. 1 is a diagram which illustrates an overall configuration according to a first embodiment.

FIG. 2 is a functional configuration diagram of a multifunction peripheral according to the first embodiment.

FIG. 3 is a diagram which illustrates destination information.

FIG. 4 is a diagram which illustrates history information.

FIG. 5 is a diagram which illustrates a flow of processing of the first embodiment.

FIG. 6 is a diagram which illustrates a flow of processing of the first embodiment.

FIG. 7 is a diagram which illustrates an operation example of the first embodiment.

FIG. 8 is a diagram which illustrates an operation example of the first embodiment.

FIG. 9 is a diagram which illustrates an operation example of the first embodiment.

FIG. 10 is a diagram which illustrates an operation example of the first embodiment.

FIG. 11 is a diagram which illustrates an operation example of the first embodiment.

FIG. 12 is a diagram which illustrates an operation example of the first embodiment.

FIG. 13 is a functional configuration diagram of a multifunction peripheral according to a second embodiment.

FIG. 14 is a diagram which illustrates an operation example of the second embodiment.

FIG. 15 is a functional configuration diagram of a multifunction peripheral according to a third embodiment.

FIG. 16 is a diagram which illustrates an operation example of the third embodiment.

FIG. 17 is a functional configuration diagram of a multifunction peripheral according to a fourth embodiment.

FIG. 18 is a diagram which illustrates an operation example of the fourth embodiment.

### DESCRIPTION OF THE PREFERRED EMBODIMENTS

Embodiments of the present disclosure will be described below with reference to the accompanying drawings. In the present disclosure, a multifunction peripheral, which executes each function such as E-mail transmission, fax transmission, or copying on a job-by-job basis, will be described as one form of an image processing apparatus. Note that the following embodiments have been presented by way of example only for describing the present disclosure, and the technical scope as recited in the appended claims is not limited by the description given below.

### 1. First Embodiment

A first embodiment is in a form related to a multifunction peripheral which stores destination information received from a terminal device in a storage, and erases the destination information from the storage in response to a trigger.

### 1.1 Overall Configuration

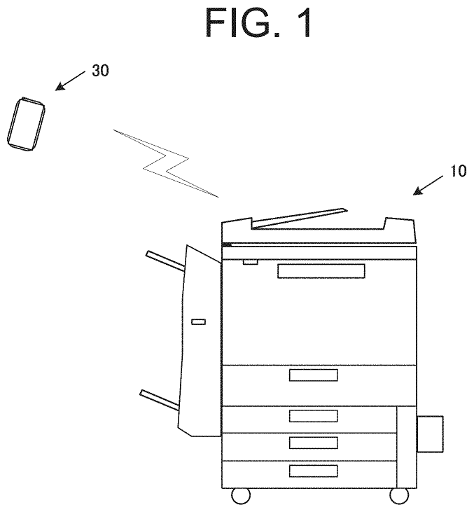

FIG. 1 is a diagram which schematically illustrates an overall configuration of a multifunction peripheral 10 according to the first embodiment. The multifunction peripheral 10 is configured such that it connects to a terminal device 30, and transmission and reception of information can be carried out mutually. FIG. 1 illustrates an example in which the multifunction peripheral 10 is directly connected to the terminal device 30 by wireless communication. However, the multifunction peripheral 10 can alternatively be connected to the terminal device 30 via a network which is not illustrated, such as a local area network (LAN), a wide area network (WAN), or the Internet.

As the terminal device 30, a smartphone, a tablet, a cellular phone, or a laptop computer, for example, in other words, the so-called mobile terminal device, is assumed. However, the terminal device 30 is not limited to the above. The terminal device of the present disclosure also includes a stationary terminal device such as a desktop computer if such a terminal device is in an environment in which communication with the multifunction peripheral 10 is enabled.

Moreover, the number of terminal devices 30 connected to the multifunction peripheral 10 is not particularly limited. When a plurality of terminal devices 30 connect to the multifunction peripheral 10, these terminal devices 30 may be of the same model configuration or a different model configuration.

### 1.2 Functional Configuration

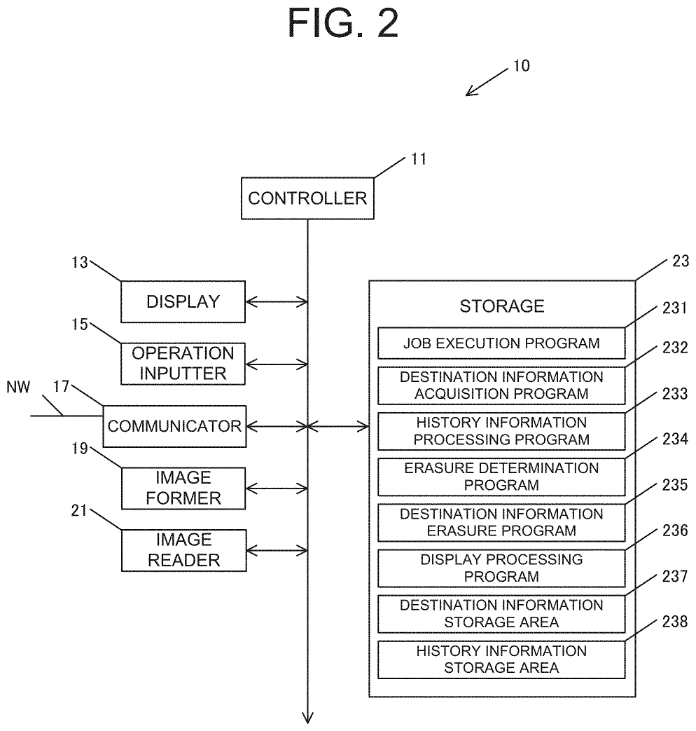

FIG. 2 is a functional configuration diagram of the multifunction peripheral 10. The multifunction peripheral 10 includes a controller 11, a display 13, an operation inputter 15, a communicator 17, an image former 19, an image reader 21, and a storage 23.

The controller 11 controls the multifunction peripheral 10 as a whole. The controller 11 is configured from, for example, one or more arithmetic devices (such as central processing units [CPUs]). The controller 11 reads and executes various programs stored in the storage 23, thereby implementing the function.

The display 13 displays various kinds of information to a user, for example. The display 13 may be configured from, for example, a liquid crystal display (LCD) or an organic electro-luminescence (EL) display.

The operation inputter 15 receives input of information made by the user, for example. The operation inputter 15 may be configured from a hardware key (e.g., a numeric keypad), buttons, and the like. The operation inputter 15 can also be configured as a touch panel that allows input to be made via the display 13. In this case, as an input method for the touch panel, a method such as a resistive film method, an infrared method, an electromagnetic induction method, or a capacitive sensing method may be employed.

The communicator 17 is provided with an interface for wireless communication such as Bluetooth (registered trademark), near field communication (NFC), Wi-fi (registered trademark), ZigBee (registered trademark), IrDA, wireless USB, and the like. The communicator 17 can also be provided with either of or both of wired/wireless interfaces to communicate with other devices via a network which is not illustrated, such as a LAN, a WAN, the Internet, a telephone line, a fax line, or the like. The multifunction peripheral 10 connects to the terminal device 30 via the communicator 17.

The image former 19 forms an image based on image data on paper, which is used as a recording medium. The image former 19 feeds paper from a paper feeder, forms an image on the paper, and then discharges the paper to a paper discharger. The image former 19 can be configured from, for example, a laser printer using an electrophotographic method. The image former 19 performs image formation by using toners supplied from toner cartridges, which are not illustrated, corresponding to respective toner colors (e.g., cyan, magenta, yellow, and black).

The image reader 21 generates image data by scanning and reading a document image to be read. The image reader 21 may be configured as a scanner device provided with an image sensor such as a charge coupled device (CCD), a contact image sensor (CIS), or the like. The configuration of the image reader 21 is not particularly limited as long as the image reader 21 is configured to read a reflected light image from a document image by the image sensor, thereby generating image data.

The storage 23 stores various programs necessary for the operation of the multifunction peripheral 10, and various kinds of data such as image data. The storage 23 may be configured from, for example, a storage device such as a random-access memory (RAM), a hard disk drive (HDD), a solid state drive (SSD), or a read-only memory (ROM).

In the first embodiment, the storage 23 stores a job execution program 231, a destination information acquisition program 232, a history information processing program 233, an erasure determination program 234, a destination information erasure program 235, and a display processing program 236, and secures a destination information storage area 237 and a history information storage area 238.

The job execution program 231 is a program that the controller 11 reads in order to perform processing associated with execution of each function, such as the E-mail transmission, fax transmission, or copying, on a job-by-job basis. The controller 11 that has read the job execution program 231 executes a job by controlling each element related to the execution of the job such as the display 13, the operation inputter 15, the communicator 17, the image former 19, or the image reader 21. The controller 11 that has read the job execution program 231 can execute various jobs based on setting values stored as history information, which will be described later.

The destination information acquisition program 232 is a program that the controller 11 reads when a request to acquire destination information is received from the user. The controller 11 that has read the destination information acquisition program 232 requests the terminal device 30 to output the destination information, such as an e-mail address, a FAX number, or a telephone number, managed by the terminal device 30. The means for acquiring the destination information is not particularly limited. For example, when communication with the terminal device 30 is to be performed by Bluetooth, a telephone book transfer profile such as a Phone Book Access Profile (PBAP) or an Object Push Profile (OPP) may be used. The controller 11 stores the destination information output in a vCard format or a CSV format, for example, in the destination information storage area 237.

The history information processing program 233 is a program that the controller 11 reads when, for example, acquisition of a setting value related to execution of a job, generation of history information, and various kinds of processing with respect to the history information are to be performed. The controller 11 that has read the history information processing program 233 stores the generated history information in the history information storage area 238.

The erasure determination program 234 is a program that the controller 11 reads in determining, in response to a trigger, whether or not to erase the destination information being retained. It is assumed that the trigger in the present disclosure means a factor or a timing which brings a device status of the multifunction peripheral 10 to a predetermined device status, and includes, for example, pressing of a specific operation button, initialization processing, transfer to an energy-saving mode, a timing of a predetermined screen transition, etc.

The destination information erasure program 235 is a program that the controller 11 reads in erasing the destination information being retained.

The display processing program 236 is a program that the controller 11 reads in displaying a history information display screen, a setting screen related to execution of a job, an inquiry screen, or a message screen, etc., which are not illustrated, on the display 13. The controller 11 that has read the display processing program 236 displays, in accordance with frame information and content arrangement information that are not illustrated, the history information display screen, the setting screen related to execution of a job, the inquiry screen, or the message screen, etc., on the display 13.

The destination information storage area 237 is a storage area for storing the destination information acquired from the terminal device 30. The destination information stored in the destination information storage area 237 is read out in executing a job using the stored destination information, or performing erasure determination regarding the destination information.

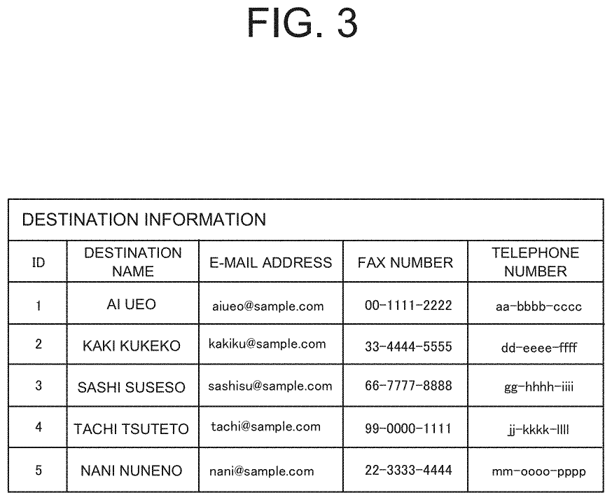

The destination information concerning the present disclosure will now be described. FIG. 3 is a diagram which illustrates one form of a data structure of the destination information (destination table) stored in the destination information storage area 237. In the present disclosure, the destination information may simply be referred to as an address.

For example, the destination information indicated as ID “1” is an example in which the E-mail address “aiueo@sample.com”, the FAX number “00-1111-2222”, and the telephone number “aa-bbbb-cccc”, as the destination information, are associated with the destination name “Ai Ueo”. For example, in a case where an E-mail transmission job with respect to the destination name “Ai Ueo” of ID “1” is to be executed, the controller 11 reads out the E-mail address “aiueo@sample.com” from the destination information stored in the destination information storage area 237. Further, as the controller 11 sets the read E-mail address to a transmission destination, an E-mail can be transmitted to a destination named “Ai Ueo”.

Note that the data structure of the destination information exemplified in FIG. 3 is merely an example, and is not limited to the example illustrated in FIG. 3. For example, it is also possible to use the data structure employed in the terminal device 30, which is an acquisition source for the destination information, in the original format.

The history information storage area 238 is a storage area for storing the history information generated by the controller 11 that has read the history information processing program 233. The history information stored in the history information storage area 238 is read out at the time of display thereof on the display 13, or executing a job using the stored history information.

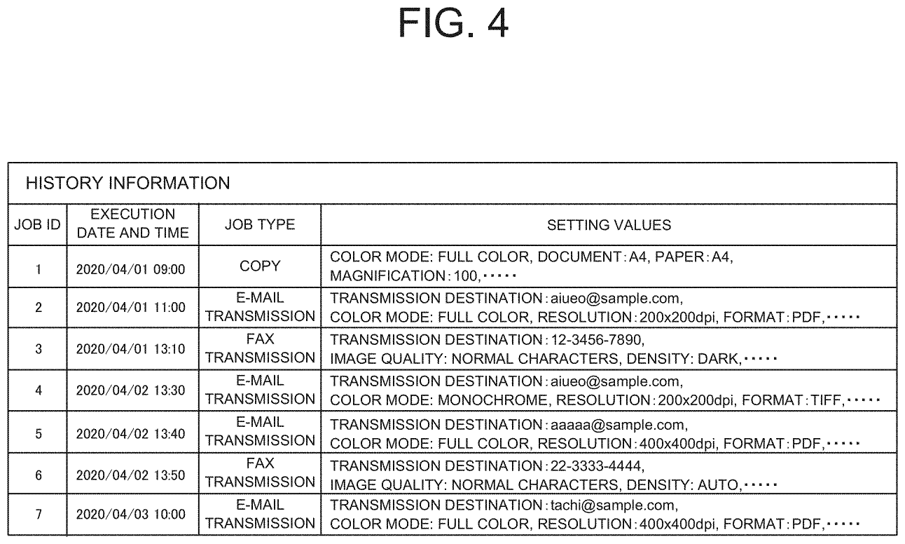

The history information concerning the present disclosure will now be described. FIG. 4 is a diagram which illustrates one form of a data structure of the history information (history table) stored in the history information storage area 238.

For example, the history information indicated as job ID “2” represents a job whose job type is the “E-mail transmission”, and which was executed on the execution date and time of “2020/04/01 11:00”. The history information related to job ID “2” includes, as the setting values, the setting values mainly related to image reading such as the color mode, resolution, data format, and the like, and also “aiueo@sample.com” as the setting value for a transmission destination of the E-mail transmission. Note that the setting values indicated in FIG. 4 are merely examples, and the setting values of the present disclosure are not limited by the matters denoted by FIG. 4 alone.

### 1.3 Processing Flow

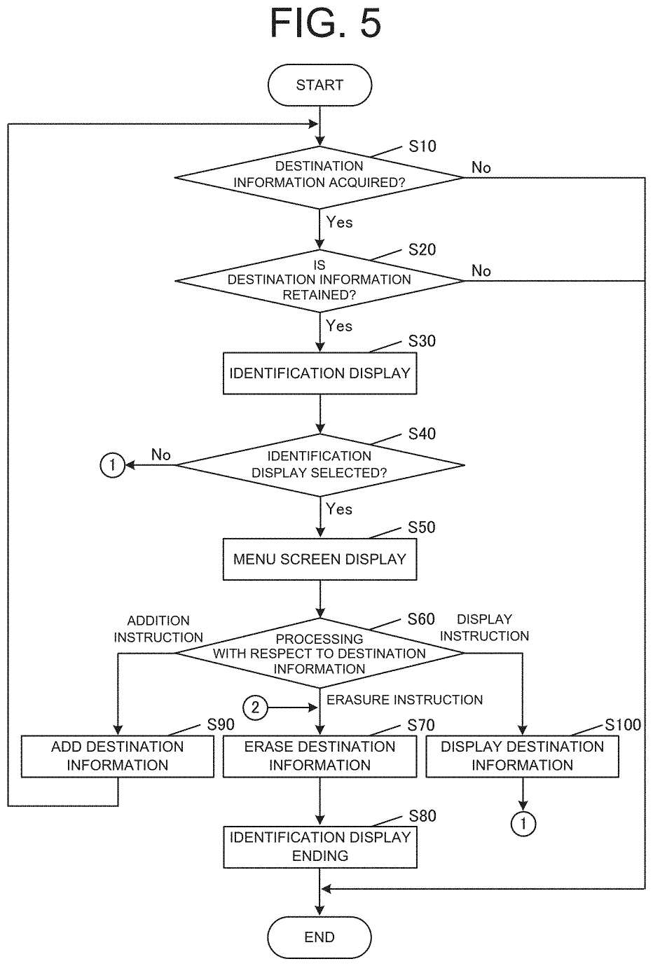

Next, a flow of processing according to the first embodiment will be described. FIG. 5 is a flowchart illustrating the flow of processing performed by the multifunction peripheral 10. The multifunction peripheral 10 implements the processing in each step by reading various programs stored in the storage 23 as appropriate.

First, the controller 11 that has read the destination information acquisition program 232 determines whether the destination information has been acquired from the terminal device 30. If the destination information has been acquired, the controller 11 determines whether the destination information is retained. (If Yes in step S10, then proceed to step S20.)

It is to be understood that the destination information being retained indicates a state in which the destination information acquired from the terminal device 30 is stored in the destination information storage area 237, and the history information using the acquired destination information is stored in the history information storage area 238, and refers to a state in which the relevant destination information has not been explicitly erased.

If the destination information is retained, the controller 11 performs identification display indicating that the destination information storage area 237 of the storage 23 stores the destination information (i.e., if Yes in step S20, then proceed to step S30). The identification display is presented identifiably on the display 13, for example, and can be configured as a selection button which can be selected by the user.

Next, the controller 11 determines whether the identification display has been selected by the user. If the identification display has been selected by the user, the controller 11 displays a menu screen to receive processing with respect to the destination information (i.e., if Yes in step S40, then proceed to step S50).

Next, the controller 11 receives selection of processing with respect to the destination information via the menu screen (step S60).

If an erasure instruction to erase the destination information is received via the menu screen, the controller 11 performs erasure processing of erasing the destination information by reading the destination information erasure program 235 (i.e., if “Erasure Instruction” applies in step S60, then proceed to step S70).

After the controller 11 has performed the erasure processing of erasing the destination information, the controller 11 ends the identification display (step S80).

Further, if an addition instruction to add the destination information is received via the menu screen, the controller 11 performs addition processing of adding the destination information (i.e., if “Addition Instruction” applies in step S60, then proceed to step S90). After performing the addition processing of adding the destination information, the controller 11 returns the processing to step S10.

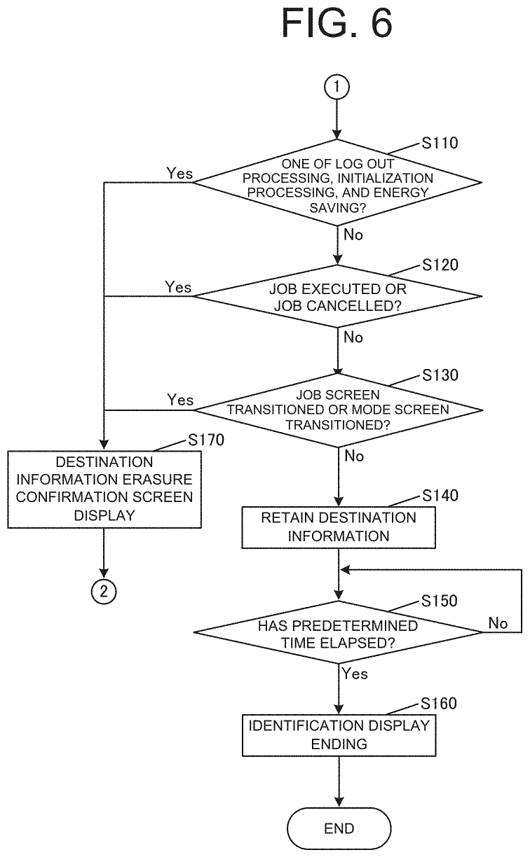

Furthermore, if a display instruction to display the destination information is received via the menu screen, the controller 11 performs display processing of displaying the destination information (i.e., if “Display Instruction” applies in step S60, then proceed to step S100). After performing the display processing of displaying the destination information, the controller 11 transfers the processing to step S110 of FIG. 6.

If the controller 11 has not acquired the destination information (step S10; No), or if the destination information is not retained (step S20; No), the processing is ended.

Also, if the identification display has not been selected by the user (step S40; No), the controller 11 transfers the processing to step S110 of FIG. 6.

FIG. 6 is a flowchart illustrating processing to be performed after the display processing of displaying the destination information of step S100 in FIG. 5, or when the identification display has not been selected by the user in step S40. Note that the processing related to FIG. 6 is that executed as the controller 11 mainly reads the erasure determination program 234.

After the display processing of displaying the destination information (step S100), or when the identification display has not been selected by the user (step S40; No), the controller 11 determines whether one of logout processing, initialization processing, and transfer to an energy-saving mode has been executed, as the timing of finishing the use of the multifunction peripheral 10.

If it is determined by the controller 11 that the user has executed one of the logout processing, the initialization processing, and the transfer to an energy-saving mode, the controller 11 displays a destination information erasure confirmation screen on the display 13 (i.e., if Yes in step S110, then proceed to step S170). After displaying the destination information erasure confirmation screen, the controller 11 erases the destination information, ends the identification display, and finishes the processing.

Meanwhile, if it is determined that the user has not executed any one of the logout processing, the initialization processing, and the transfer to an energy-saving mode, the controller 11 determines whether a job has been executed or canceled as the timing of finishing the use of the destination information by the user (i.e., if No in step S110, then proceed to step S120).

If it is determined by the controller 11 that the job has been executed or canceled by the user, the controller 11 displays the destination information erasure confirmation screen on the display 13 (i.e., if Yes in step S120, then proceed to step S170). After displaying the destination information erasure confirmation screen, the controller 11 erases the destination information, ends the identification display, and finishes the processing.

Meanwhile, if it is determined that the job has neither been executed nor canceled by the user, the controller 11 determines whether either a screen transition from one of a fax job screen and an image transmission job screen to another job screen, or a screen transition from one of a simple scan mode screen and a simple fax mode screen to another mode screen has been made by the user (i.e., if No in step S120, then proceed to step S130).

If it is determined by the controller 11 that the screen transition from one of the fax job screen and the image transmission job screen to another job screen, or the screen transition from one of the simple scan mode screen and the simple fax mode screen to another mode screen has been made by the user, the controller 11 displays the destination information erasure confirmation screen on the display 13 (i.e., if Yes in step S130, then proceed to step S170). After displaying the destination information erasure confirmation screen, the controller 11 erases the destination information, ends the identification display, and finishes the processing.

Meanwhile, if it is determined that neither the screen transition from one of the fax job screen and the image transmission job screen to another job screen, nor the screen transition from one of the simple scan mode screen and the simple fax mode screen to another mode screen has been made by the user, the controller 11 retains the destination information (i.e., if No in step S130, then proceed to step S140).

Then, the controller 11 determines whether a predetermined time has elapsed from the display of the identification display (step S150). If the predetermined time has elapsed from the display of the identification display, the controller 11 ends the identification display (i.e., if Yes in step S150, then proceed to step S160). Meanwhile, the controller 11 continues the identification display until the predetermined time elapses from the display of the identification display (step S150; No).

### 1.4 Operation Example

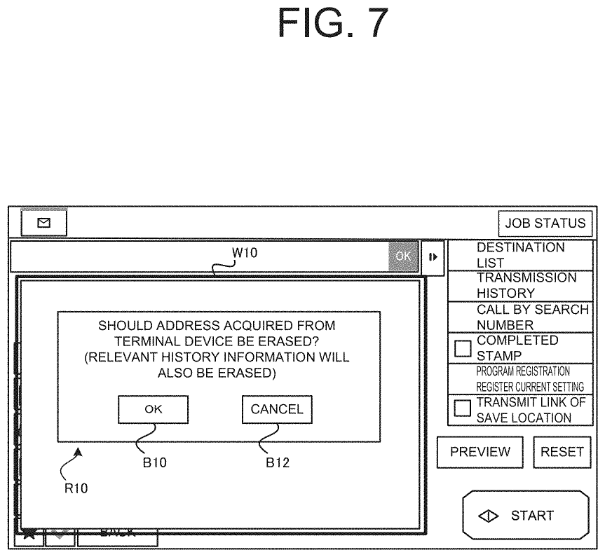

Next, an operation example according to the first embodiment will be described. FIG. 7 shows a configuration example of a destination information erasure confirmation screen W10 that the controller 11 displays on the display 13 in step S170 of FIG. 6.

The destination information erasure confirmation screen W10 includes a message display area R10 which confirms with the user whether an address, which is used as the destination information acquired from the terminal device 30, should be erased or not, an OK button B10 which receives an erasure instruction, and a cancel button B12 which receives cancellation of the erasure instruction.

When the user wishes to erase an address, he/she can erase the address by pressing the OK button B10. Meanwhile, when erasure of an address is not desired, the erasure of the address can be cancelled by pressing the cancel button B12.

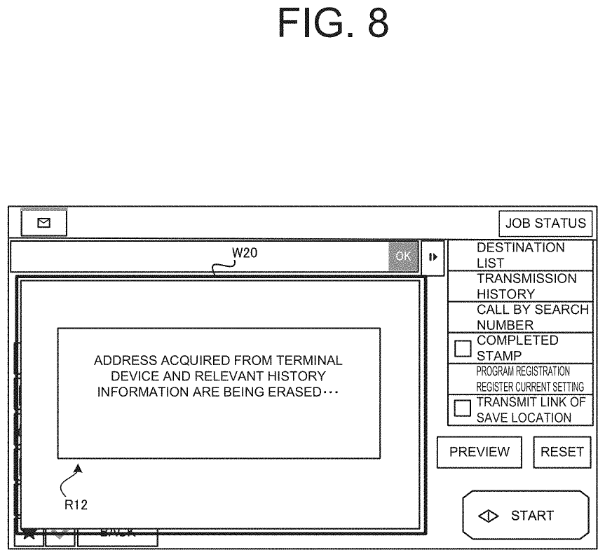

FIG. 8 shows a configuration example of an erasure status notification screen W20 that the controller 11 displays on the display 13 in response to pressing of the OK button B10 on the destination information erasure confirmation screen W10. The erasure status notification screen W20 includes an erasure status notification area R12 which notifies the user of an erasure status of the address by indicating “Address acquired from terminal device and relevant history information are being erased . . . ”, for example. The user can ascertain the erasure status of the address by checking the contents notified in the erasure status notification area R12.

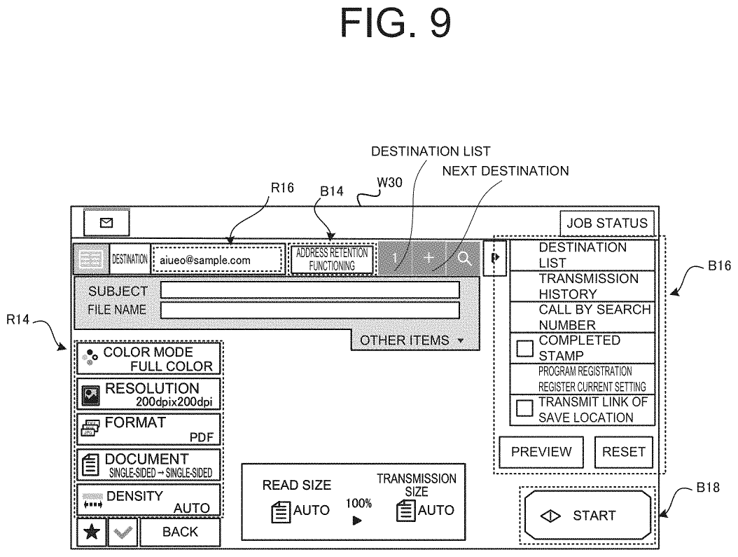

FIG. 9 is a diagram which illustrates a configuration example of a job execution screen W30 related to an E-mail transmission job using the history information. The job execution screen W30 includes an address-retention-functioning button B14 used as the identification display, a processing selection button B16, a start button B18, a setting information display area R14, and a transmission destination display area R16. Note that the job execution screen W30 can be displayed via a home screen which is not illustrated, for example.

The address-retention-functioning button B14 is configured to explicitly display the state in which the destination information is being retained, and to enable reception of the selection by the user. In response to pressing of the address-retention-functioning button B14, the controller 11 displays a menu screen W40 to receive selection of processing with respect to the address.

The processing selection button B16 is a button which receives selection of processing as desired by the user. The processing selection button B16 includes buttons which receive selection of processing as desired by the user, such as “Destination List”, “Transmission History”, “Call by Search Number”, “Completed Stamp”, “Program Registration”, and “Transmit Link of Save Location”. For example, as the user presses the “Destination List” button, he/she can cause the addresses managed by the multifunction peripheral 10 itself to be displayed, in addition to the addresses acquired from the terminal device 30.

The start button B18 is a button which receives an instruction input to execute the E-mail transmission job. As the user presses the start button B18 after confirming the setting details on the job execution screen W30, he/she can execute the E-mail transmission job.

The setting information display area R14 is an area in which each piece of setting information related to the E-mail transmission job is displayed. The setting values included in the history information selected by the user are applied and displayed in the setting information display area R14. FIG. 9 shows an example in which the setting values that are full color, as the color mode, 200 dpi×200 dpi, as the resolution, and PDF, as the data format, for example, included in the history information related to job ID “2” illustrated in FIG. 4, are applied.

The transmission destination display area R16 is an area in which a transmission destination address of the E-mail transmission job is displayed. In the transmission destination display area R16, the destination information (transmission destination address: aiueo@sample.com) included in the applied history information (job ID “2”) as the setting value is set.

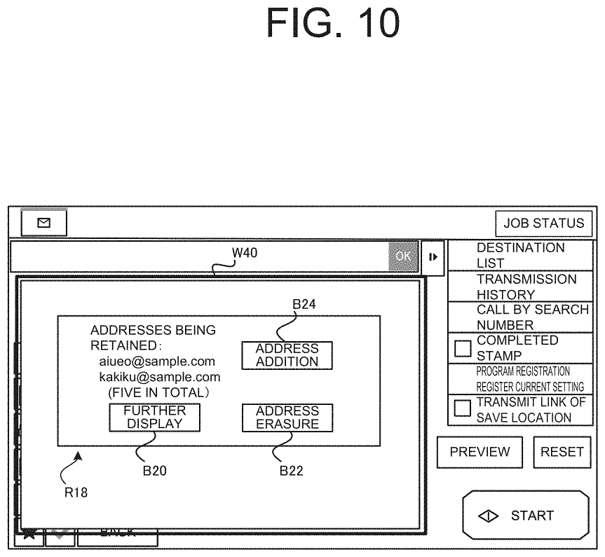

FIG. 10 shows a configuration example of the menu screen W40 that the controller 11 displays on the display 13 in response to pressing of the address-retention-functioning button B14 on the job execution screen W30 of FIG. 9. The menu screen W40 includes a menu display area R18, a further display button B20, an address erasure button B22, and an address addition button B24.

The menu display area R18 secures a display area for the further display button B20 and the like, and also includes an address display area for displaying (some) addresses retained by the multifunction peripheral 10.

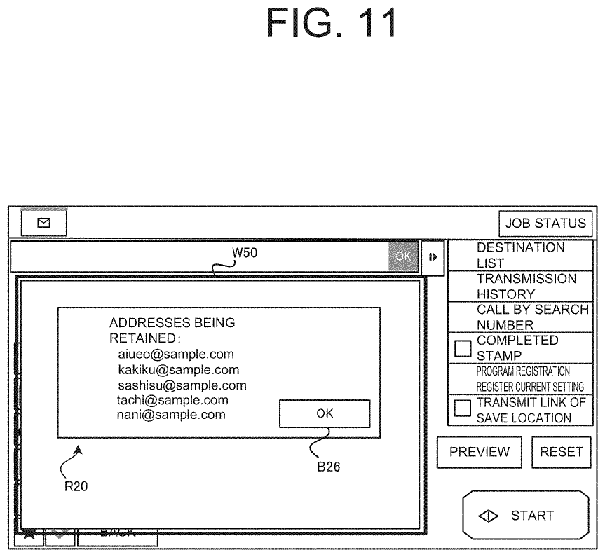

The further display button B20 is a button which receives, when the addresses displayed in the address display area are those which constitute a part of the addresses being retained by the multifunction peripheral 10, an instruction input to further display the remaining (hidden) addresses. When the further display button B20 is pressed by the user, the controller 11 displays a whole address display screen W50, which will be described with reference to FIG. 11, on the display 13. If all of the addresses cannot be fully displayed in the address display area, a scroll bar or the like may be displayed so that all of the addresses can be displayed by switching the display.

FIG. 11 shows a configuration example of the whole address display screen W50 that the controller 11 displays on the display 13 in response to pressing of the further display button B20 on the menu screen W40. The whole address display screen W50 includes a whole address display area R20, and an OK button B26.

The whole address display area R20 is a display area for displaying all of the E-mail addresses (FIG. 4) retained by the multifunction peripheral 10. The example of FIG. 11 shows that only the E-mail addresses are displayed as the addresses retained by the multifunction peripheral 10. However, as the addresses to be displayed, FAX numbers and telephone numbers can also be displayed, in addition to the E-mail addresses. In the whole address display area R20, it is sufficient if the address, which is used as the destination information retained by the multifunction peripheral 10, can be specified, and there is no restriction on the type of addresses to be displayed.

The OK button B26 is a button which receives pressing thereof by the user who has confirmed the addresses displayed in the whole address display area R20. When the OK button B26 is pressed by the user, the controller 11 returns the screen to the menu screen W40.

Now back to FIG. 10 again, the address erasure button B22 is a button which receives an instruction input to erase the addresses being retained by the multifunction peripheral 10. When the address erasure button B22 is pressed by the user, the controller 11 erases the addresses used as the destination information that are stored in the destination information storage area 237. Furthermore, together with the erasure of the address, when history information using the address to be erased is stored in the history information storage area 238, the controller 11 also erases the corresponding history information. In the erasure of the history information, the erasure may be performed such that only the address used as the destination information that is included in the applicable history information is erased.

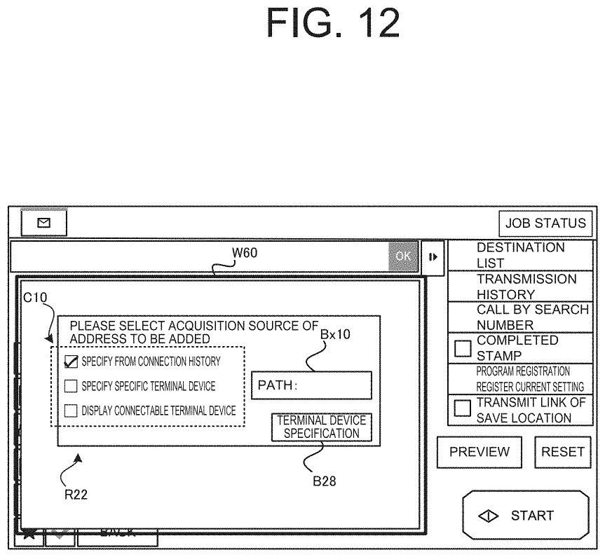

The address addition button B24 is a button which receives an instruction input when an address is to be added. When the address addition button B24 is pressed by the user, the controller 11 displays an address addition screen W60, which will be described with reference to FIG. 12, on the display 13.

FIG. 12 shows a configuration example of the address addition screen W60 that the controller 11 displays on the display 13 in response to pressing of the address addition button B24 on the menu screen W40. The address addition screen W60 includes an acquisition source selection display area R22, an acquisition source selection checkbox C10, a path input box Bx10, and a terminal device specification button B28.

The acquisition source selection display area R22 displays a message prompting the user to select an acquisition source for the address to be added, and also secures a display area for the acquisition source selection checkbox C10 and the like.

The acquisition source selection checkbox C10 is a checkbox to receive selection of a specification method for the terminal device 30 corresponding to an acquisition source for the address to be added. FIG. 12 illustrates, as the selectable specification method, each one of “Specify from Connection History (on multifunction peripheral 10)”, “Specify Specific Terminal Device”, and “Display Connectable Terminal Device”, by way of example. As the user puts a check in the desired item, he/she can specify the terminal device 30 corresponding to the acquisition source for the address to be added.

For example, when “Specify from Connection History” is selected by the user, the controller 11 refers to connection history information on the multifunction peripheral of its own. The controller 11 displays, in light of the connection history information, the terminal device 30 with which a connection history is constituted on a display screen which is not illustrated. If there is more than one terminal device 30 with which the connection history is constituted, it is possible to preferentially display the one with a recent connection history, or preferentially display the connection history related to the terminal device 30 which is close in distance to the multifunction peripheral 10. Further, as the controller 11 receives selection of the terminal device 30 by the user, the controller 11 specifies the acquisition source for the address to be added.

Also, when “Specify Specific Terminal Device” is selected by the user, the controller 11 specifies the terminal device 30 with which connection can be established on the basis of a connection path input in the path input box Bx10, as the acquisition source for the address to be added.

Furthermore, when “Display Connectable Terminal Device” is selected by the user, the controller 11 detects the connectable terminal device 30 that is located in the vicinity of the multifunction peripheral of its own and displays such a terminal device 30 on a display screen not illustrated. If there is more than one terminal device 30 with which the connection history is constituted, it is possible to preferentially display the one with a recent connection history, or preferentially display the connection history related to the terminal device 30 which is close in distance to the multifunction peripheral 10. Further, as the controller 11 receives selection of the terminal device 30 by the user, the controller 11 specifies the acquisition source for the address to be added.

The terminal device specification button B28 is a button which receives a confirmation input regarding the specification method for the terminal device 30 selected via the acquisition source selection checkbox C10. As the user puts a check in the acquisition source selection checkbox C10, and presses the terminal device specification button B28, the controller 11 specifies the terminal device 30 to be used as the acquisition source for the address, on the basis of the selected specification method. Further, the controller 11 makes an address acquisition request to the specified terminal device 30. When the terminal device 30 which received the address acquisition request has an address which can be added, the controller 11 can acquire the address, thereby carrying out addition of addresses.

As described above, according to the first embodiment, it is possible to provide an image processing apparatus and the like capable of handling destination information with consideration to security, while ensuring convenience pertaining to the use of destination information acquired from a terminal device.

### 2 Second Embodiment

It has been described that the multifunction peripheral according to the first embodiment has the configuration in which all addresses used as the destination information that are stored in the destination information storage area 237 are erased. A second embodiment is in a form of a multifunction peripheral which can prevent an address intended to be used by the user from being unnecessarily erased by adopting a structure of erasing only the selected address.

### 2.1 Functional Configuration

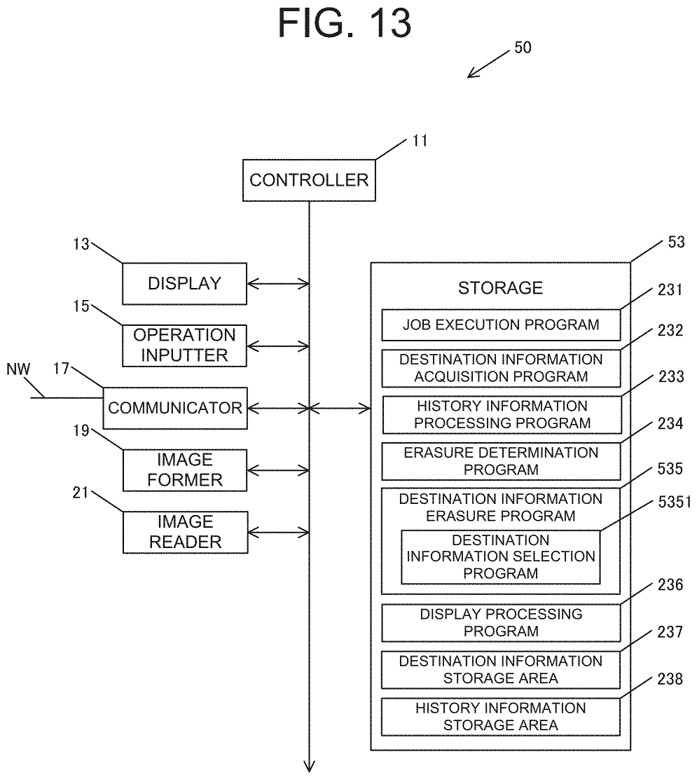

FIG. 13 is a functional configuration diagram which illustrates a functional configuration of a multifunction peripheral 50 according to a second embodiment. Note that the same configuration as that of the multifunction peripheral 10 according to the first embodiment may be denoted by the same reference numerals, and the description thereof may be omitted.

The multifunction peripheral 50 is provided with a controller 11, a display 13, an operation inputter 15, a communicator 17, an image former 19, an image reader 21, and a storage 53.

In the second embodiment, the storage 53 stores a job execution program 231, a destination information acquisition program 232, a history information processing program 233, an erasure determination program 234, a destination information erasure program 535, and a display processing program 236, and secures a destination information storage area 237 and a history information storage area 238.

The destination information erasure program 535 is a program that the controller 11 reads in erasing an address being retained. The destination information erasure program 535 according to the second embodiment includes a destination information selection program 5351 that the controller 11 reads in receiving selection of an address that the user wishes to erase.

The controller 11 which has read the destination information selection program 5351 displays, on the display 13, a destination information selection screen to receive selection of an address that the user wishes to erase.

### 2.2 Processing Flow

A flow of processing according to the second embodiment can be made substantially the same as the flow of processing described with reference to the flowcharts of FIGS. 5 and 6 of the first embodiment. A destination information selection screen W70 to be described with reference to the figure mentioned below can be displayed as, for example, processing of a stage prior to the erasure processing for an address concerning step S70 of FIG. 5.

### 2.3 Operation Example

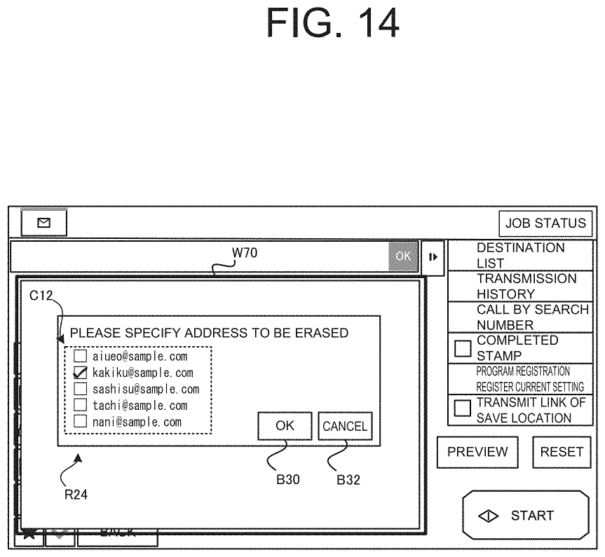

FIG. 14 shows a configuration example of the destination information selection screen W70 to receive selection of an address that the user wishes to erase. The destination information selection screen W70 includes a selected address display area R24, a selected address checkbox C12, an OK button B30, and a cancel button B32.

The selected address display area R24 displays a message prompting the user to select an address to be erased, and also secures a display area for the selected address checkbox C12 and the like.

The selected address checkbox C12 is a checkbox to receive selection of an address that the user wishes to erase. As the user puts a check in the checkbox corresponding to the address that he/she wishes to erase, the user can select the address to be erased.

The OK button B30 receives an instruction to confirm the selection of the address to be erased. Meanwhile, the cancel button B32 receives an instruction to cancel the selection of the address to be erased. As the user puts a check in the checkbox corresponding to the address that he/she wishes to erase, and presses the OK button B30, the controller 11 erases the address stored in the destination information storage area 237. Furthermore, together with the erasure of the address, when history information using the address to be erased is stored in the history information storage area 238, the controller 11 also erases the corresponding history information. In the erasure of the history information, the erasure may be performed such that only the address used as the destination information that is included in the applicable history information is erased.

As described above, according to the second embodiment, not only is it possible to obtain the advantages related to the first embodiment, but it is also possible to prevent destination information intended to be used by the user from being unnecessarily erased because only the destination information that the user wishes to erase can be erased.

### 3 Third Embodiment

It has been described that the multifunction peripheral according to the first embodiment has the configuration in which the addresses used as the destination information that are stored in the destination information storage area 237 are immediately erased after the display of the destination information erasure confirmation screen. A third embodiment is in a form of a multifunction peripheral which can make effective use of an address that is intended to be erased, by allowing the timing of erasing the address to be settable.

### 3.1 Functional Configuration

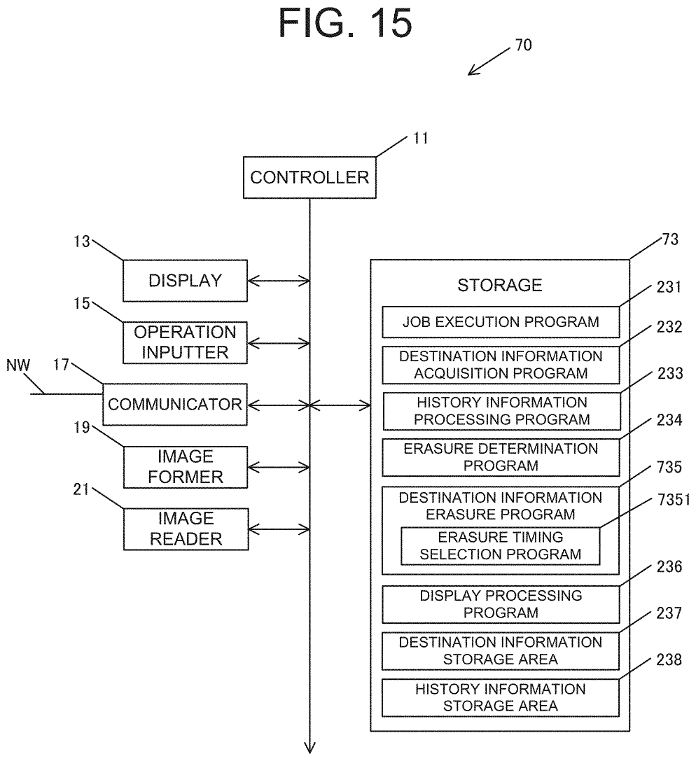

FIG. 15 is a functional configuration diagram which illustrates a functional configuration of a multifunction peripheral 70 according to a third embodiment. Note that the same configuration as that of the multifunction peripheral 10 according to the first embodiment may be denoted by the same reference numerals, and the description thereof may be omitted.

The multifunction peripheral 70 is provided with a controller 11, a display 13, an operation inputter 15, a communicator 17, an image former 19, an image reader 21, and a storage 73.

In the third embodiment, the storage 73 stores a job execution program 231, a destination information acquisition program 232, a history information processing program 233, an erasure determination program 234, a destination information erasure program 735, and a display processing program 236, and secures a destination information storage area 237 and a history information storage area 238.

The destination information erasure program 735 is a program that the controller 11 reads in erasing an address being retained. The destination information erasure program 735 according to the third embodiment includes an erasure timing selection program 7351 that the controller 11 reads in receiving selection of an address erasure timing.

The controller 11 which has read the erasure timing selection program 7351 displays, on the display 13, an erasure timing selection screen W80 to receive selection of an erasure timing of erasing the address.

### 3.2 Processing Flow

A flow of processing according to the third embodiment can be made substantially the same as the flow of processing described with reference to the flowcharts of FIGS. 5 and 6 of the first embodiment. The erasure timing selection screen W80 to be described with reference to the figure mentioned below can be displayed as, for example, processing of a stage prior to the erasure processing for an address concerning step S70 of FIG. 5.

### 3.3 Operation Example

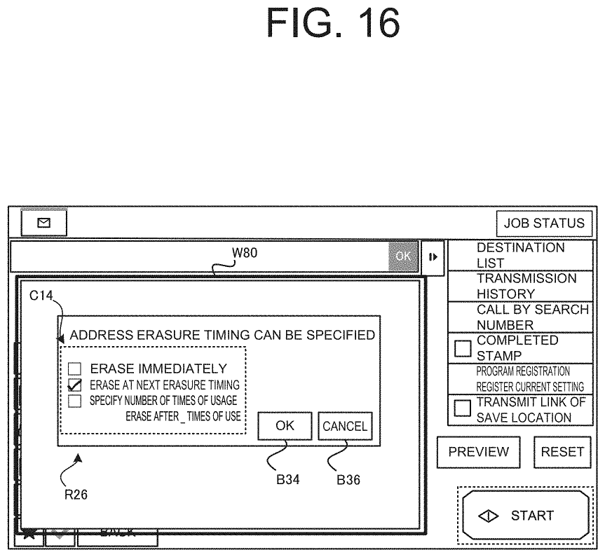

FIG. 16 shows a configuration example of the erasure timing selection screen W80 to receive selection of an erasure timing as desired by the user. The erasure timing selection screen W80 includes an erasure timing display area R26, an erasure timing selection checkbox C14, an OK button B34, and a cancel button B36.

The erasure timing display area R26 displays a message prompting the user to select an address erasure timing, and also secures a display area for the erasure timing selection checkbox C14 and the like.

The erasure timing selection checkbox C14 is a checkbox to receive selection of the erasure timing of erasing the address. As the user puts a check in the checkbox corresponding to the erasure timing as desired, the user can select the erasure timing.

FIG. 16 illustrates, as the address erasure timing, “Erase Immediately”, “Erase at Next Erasure Timing”, and “Specify Number of Times of Usage”, by way of example. For example, when “Erase at Next Erasure Timing” is selected by the user, the controller 11 does not immediately erase the address, but retains the address until the next erasure timing arrives. Further, when “Specify Number of Times of Usage” is selected by the user, the controller 11 erases the address at the stage when the number of times of usage of the address intended to be erased reaches a predetermined number.

The OK button B34 receives an instruction to confirm the selection of the erasure timing. Meanwhile, the cancel button B36 receives an instruction to cancel the selection of the erasure timing. As the user puts a check in the checkbox corresponding to the erasure timing as desired, and presses the OK button B34, the controller 11 erases the address stored in the destination information storage area 237 at the selected erasure timing. Furthermore, together with the erasure of the address, when history information using the address to be erased is stored in the history information storage area 238, the controller 11 also erases the corresponding history information. In the erasure of the history information, the erasure may be performed such that only the address used as the destination information that is included in the applicable history information is erased.

As described above, according to the third embodiment, the destination information can be erased at the erasure timing as desired by the user. Therefore, for example, even if it is necessary to perform E-mail transmission multiple times to the same destination, the destination information intended to be used will be erased at the selected erasure timing. Consequently, it is possible to reliably erase the destination information while ensuring convenience pertaining to the use of the destination information.

### 4 Fourth Embodiment

It has been described that the multifunction peripheral according to the first embodiment has the configuration in which, together with the erasure of the address used as the destination information that is stored in the destination information storage area 237, when history information using the address to be erased is stored in the history information storage area 238, the corresponding history information is also erased. A fourth embodiment is in a form of a multifunction peripheral which can retain history information for which the user does not desire erasure processing by employing a configuration in which history information, which becomes an erasure target due to erasure of an address, is allowed to be selectable.

### 4.1 Functional Configuration

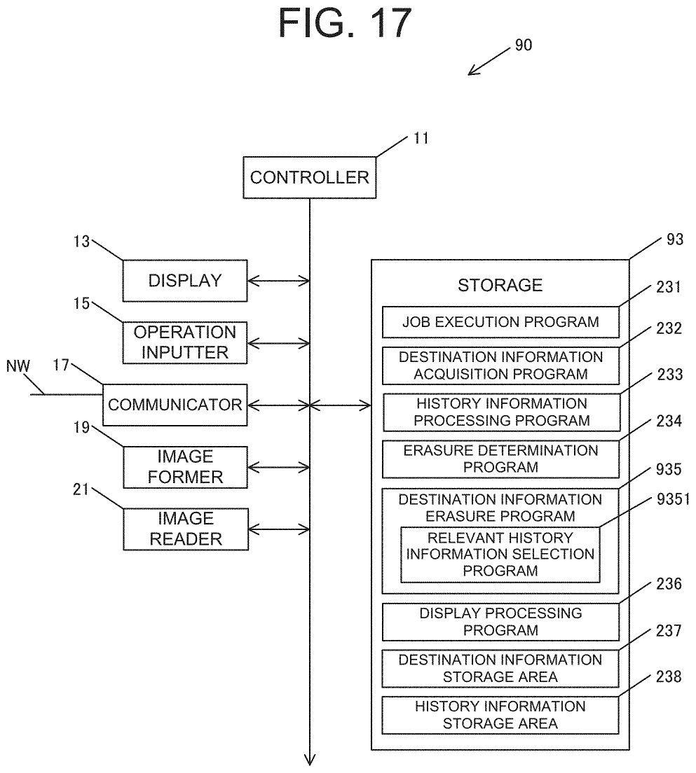

FIG. 17 is a functional configuration diagram which illustrates a functional configuration of a multifunction peripheral 90 according to a fourth embodiment. Note that the same configuration as that of the multifunction peripheral 10 according to the first embodiment may be denoted by the same reference numerals, and the description thereof may be omitted.

The multifunction peripheral 90 is provided with a controller 11, a display 13, an operation inputter 15, a communicator 17, an image former 19, an image reader 21, and a storage 93.

In the fourth embodiment, the storage 93 stores a job execution program 231, a destination information acquisition program 232, a history information processing program 233, an erasure determination program 234, a destination information erasure program 935, and a display processing program 236, and secures a destination information storage area 237 and a history information storage area 238.

The destination information erasure program 935 is a program that the controller 11 reads in erasing an address being retained. The destination information erasure program 935 according to the fourth embodiment includes a relevant history information selection program 9351 that the controller 11 reads in receiving selection of history information of the erasure target.

The controller 11 which has read the relevant history information selection program 9351 displays, on the display 13, a relevant history information selection screen to receive selection of the history information of the erasure target.

### 4.2 Processing Flow

A flow of processing according to the fourth embodiment can be made substantially the same as the flow of processing described with reference to the flowcharts of FIGS. 5 and 6 of the first embodiment. A relevant history information selection screen W90 to be described with reference to the figure mentioned below can be displayed as, for example, processing of a stage prior to the erasure processing for the destination information concerning step S70 of FIG. 5.

### 4.3 Operation Example

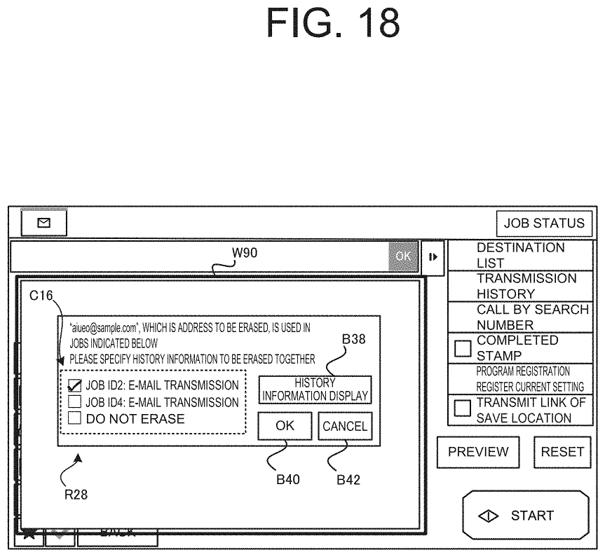

FIG. 18 shows a configuration example of the relevant history information selection screen W90 to receive selection of the history information that the user wishes to erase. The relevant history information selection screen W90 includes an erasure target history information display area R28, an erasure target history information selection checkbox C16, a history information display button B38, an OK button B40, and a cancel button B42.

The erasure target history information display area R28 displays a message prompting the user to select history information of the erasure target, and also secures a display area for the erasure target history information selection checkbox C16 and the like.

The erasure target history information selection checkbox C16 is a checkbox to receive selection of the history information of the erasure target. As the user puts a check in the checkbox corresponding to the history information to be erased together with the erasing of the address, the user can select the history information of the erasure target.

FIG. 18 shows an example in which pieces of history information using “aiueo@sample.com”, which is the address to be erased, are displayed as the history information of the erasure target (see FIG. 4). For example, when history information related to “Job ID2: E-mail transmission” is selected by the user, the controller 11 erases the history information related to the selected “Job ID2: E-mail transmission” together with the erasure of the address “aiueo@sample.com”. At this time, since “Job ID4: E mail transmission” is not selected by the user, history information corresponding thereto is not erased.

If the details of the history information of the erasure target which is displayed in the erasure target history information display area R28 are uncertain, the user can confirm the details (setting values) of the history information by pressing the history information display button B38.

The OK button B40 receives an instruction to confirm the selection of the history information of the erasure target. Meanwhile, the cancel button B42 receives an instruction to cancel the selection of the history information. As the user puts a check in the checkbox corresponding to the history information that he/she wishes to erase, and presses the OK button B40, the controller 11 erases the address stored in the destination information storage area 237, and also erases the selected history information from the history information storage area 238.

When no history information of the erasure target is selected via the relevant history information selection screen W90, the history information continues to include the destination information. In this case, when the history information is to be displayed, the part pertaining to the destination information can be hidden from display or partially concealed to ensure security of the destination information.

As described above, according to the fourth embodiment, not only is it possible to obtain the advantages related to the first embodiment, but it is also possible to select the history information to be erased together with the erasing of the destination information. Therefore, it is possible to prevent history information of a job executed on the basis of special settings, or history information having high utility value for the user, for example, from being unnecessarily erased together with the erasure of the destination information.

The present disclosure is not limited to the above-described embodiments, and various modifications can be made. That is, the present disclosure also includes, in the technical scope thereof, embodiments obtained by combining technical means modified as appropriate without departing from the spirit of the present disclosure.

Further, although some parts of the above embodiments have been described separately for convenience of explanation, it is needless to say that the embodiments described separately may be combined within a technically possible range and implemented.

In addition, the program to be operated on each of the devices in the embodiments is a program which controls the CPU or the like (i.e., a program which makes a computer function) so as to implement the functions of the above-described embodiments. Further, the information handled by these devices is temporarily accumulated in a temporary storage device (e.g., a RAM) during the processing, is then stored in various storage devices such as a read-only memory (ROM) and an HDD, and is read, corrected, and written by the CPU as needed.

Here, as the recording medium for storing the program, a semiconductor medium (e.g., a ROM or a non-volatile memory card), an optical recording medium/magneto-optical recording medium (e.g., a digital versatile disc (DVD), a magneto optical disc (MO), a mini disc (MD), a compact disc (CD), or a Blu-ray Disk (BD) [registered trademark]), a magnetic recording medium (e.g., a magnetic tape or a flexible disk), etc., may be used. Further, not only are the functions of the above-described embodiments implemented by execution of the loaded program, but the functions of the present disclosure may also be implemented by processing performed in cooperation with an operating system or other application programs, etc., on the basis of the instructions of the program.

Furthermore, when the program is to be distributed to the market, the program may be stored in a portable recording medium for distribution or transferred to a server computer connected via a network such as the Internet. In this case, it is needless to say that the present disclosure also includes a storage device of the server computer.

What is claimed is:

1. An image processing apparatus comprising a communicator, a storage, and a controller, wherein
the controller:
stores destination information received from a terminal device, via the communicator, in the storage; and
erases the destination information from the storage in response to a trigger,
the destination information being retained at least until a trigger input is made.

2. The image processing apparatus according to claim 1, wherein the controller assumes a timing at which use of the image processing apparatus is finished as the trigger.

3. The image processing apparatus according to claim 2, wherein the timing at which the use of the image processing apparatus is finished is any one of timings of logout processing, initialization processing, and transfer to an energy-saving mode.

4. The image processing apparatus according to claim 1, wherein the controller assumes a timing at which use of the destination information is finished as the trigger.

5. The image processing apparatus according to claim 4, wherein the timing at which the use of the destination information is finished is either after execution of a job using the destination information, or a timing at which a job using the destination information is cancelled.

6. The image processing apparatus according to claim 1, wherein the controller assumes a timing of a screen transition as the trigger.

7. The image processing apparatus according to claim 6, wherein the timing of the screen transition is either a timing of a screen transition from one of a fax job screen and an image transmission job screen to another job screen, or a timing of a screen transition from one of a simple scan mode screen and a simple fax mode screen to another mode screen.

8. The image processing apparatus according to claim 1, further comprising a display, wherein
the controller performs identification display, on the display, indicating that the destination information is stored in the storage.

9. The image processing apparatus according to claim 8, wherein the controller displays a menu screen on the display when the identification display is selected, and the menu screen includes an operation button to accept erasure of the destination information.

10. The image processing apparatus according to claim 8, wherein:
the storage further stores a destination table; and
the controller adds the destination information to the destination table when the identification display is selected.

11. The image processing apparatus according to claim 1, wherein the controller receives specification of the destination information to be erased.

12. The image processing apparatus according to claim 1, wherein the controller receives specification of an erasure timing for the destination information.

13. The image processing apparatus according to claim 1, wherein:
the storage further stores history information regarding a history of an executed job; and
the controller erases, when erasing the destination information from the storage, the history information regarding a job using the destination information.

14. The image processing apparatus according to claim 13, wherein the controller receives selection of the history information using the destination information.

15. A method for controlling an image processing apparatus, the method comprising:
storing destination information received from a terminal device in a storage; and
erasing the destination information from the storage in response to a trigger,
the destination information being retained at least until a trigger input is made.
